(19) United States
(12) Patent Application Publication
(10) Pub. No.: US 2025/0305847 A1
(43) Pub. Date: Oct. 2, 2025

(54) ELECTRIC VEHICLE CHARGING POINT DETECTION SYSTEM

(71) Applicant: HERE GLOBAL B.V., EINDHOVEN (NL)

(72) Inventors: PAVEL IVANOV, TAMPERE (FI); LAURI AARNE JOHANNES WIROLA, TAMPERE (FI); MARKO LUOMI, TAMPERE (FI); HENRI NURMINEN, TAMPERE (FI)

(73) Assignee: HERE GLOBAL B.V., EINDHOVEN (NL)

(21) Appl. No.: 18/624,150

(22) Filed: Apr. 2, 2024

(51) Int. Cl. G01C 21/36; B60W 60/00; G07C 5/00; G07C 5/02

(52) U.S. Cl. CPC G01C 21/3685; G07C 5/008; G07C 5/02; B60W 60/001

(57) ABSTRACT

An apparatus configured to, with a processor, cause the apparatus to at least collect real-time driving data for at least one vehicle from a mobile device associated with a user of the vehicle or a navigation unit of the vehicle, wherein the collected real-time driving data includes at least parking location information for the vehicle; retrieve historical driving data associated with the at least one vehicle from one or more databases; retrieve point of interest (POI) data from one or more databases; generate a vehicle type prediction associated with the vehicle based on the collected real-time driving data, the retrieved historical driving data, and the POI data, wherein the generated vehicle type prediction is stored in the one or more databases; and generate an electrical vehicle charge point location prediction based on at least the vehicle type prediction and parking location information for at least one vehicle.

### TECHNOLOGICAL FIELD

The field of the present disclosure relates to identifying locations for electric vehicle (EV) charging points, and more particularly, unknown or unmapped charging point detection for use by EVs.

### BACKGROUND

Electric vehicle (EV) adoption has become widespread and is predicted to continue to grow strongly in the upcoming years. EVs are generally efficient and emit fewer emissions while driving when compared to traditional vehicles with internal combustion engines (ICEs). However, the EV charging infrastructure available in most countries substantially lags compared to the petroleum fuel infrastructure and is struggling to keep pace with the EV adoption rate.

In some cases, the charging infrastructure features EV charging stations that have too few charging points for which there is too much demand. Other issues include broken chargers, high rates (cost), and confusion about how to pay as well as how long is needed to charge the EV. Moreover, there are multiple connector types and multiple charging speeds for some charging points.

A charging event for a given EV may also be dependent on vehicle characteristics (such as, but not limited to, a battery type, age of the battery, and remaining power of the battery) and external factors (such as, but not limited to, a temperature at the EV charging stations, and parallel usage of other chargers at the EV charging station). Such factors may make it difficult for a user of the EV to identify a suitable charging station for their charging needs. Additionally, the rate at which new charging stations are being installed has exponentially increased and records of where and when such stations, plugs, etc. have been installed lags (as does the data on new charger characteristics, etc.). These charging locations may also be offline sporadically for any number of reasons.

### BRIEF SUMMARY

The system, apparatus, method, etc. of the present disclosure may crowd source data from vehicles or from mobile devices associated with the users of vehicles, such as a mobile phone, tablet, etc. The apparatus may be configured to utilize real-time driving data and historical driving data related to the use and parking locations of said vehicles to identify and predict a charging point location for one or more electric vehicles (EVs). The charging point location prediction may then be utilized to generate recommendations for the most suitable charging points for a given EV. Thus, the apparatus of the present disclosure may not depend on the charging point operators or data aggregators for data related to charging point locations and their availability.

One embodiment may be described as a system or apparatus comprising at least one processor and at least one memory including computer program code, the at least one memory and computer program code configured to, with the processor, cause the apparatus to at least collect real-time driving data for at least one vehicle from a mobile device associated with a user of the vehicle or a navigation unit of the vehicle, wherein the collected real-time driving data includes at least parking location information for the vehicle; retrieve historical driving data associated with the at least one vehicle from one or more databases; retrieve point of interest (POI) data from one or more databases; generate a vehicle type prediction associated with the vehicle based on the collected real-time driving data, the retrieved historical driving data, and the POI data, wherein the generated vehicle type prediction is stored in the one or more databases; and generate an electrical vehicle charge point location prediction based on at least the vehicle type prediction and parking location information for at least one vehicle.

This apparatus may also include an electrical vehicle charge point location prediction which is based on the vehicle type prediction and parking location information for at least two vehicles. The electrical vehicle charge point location prediction may also be based on aggregated vehicle type prediction and parking location information for vehicles in a town, city, or neighborhood. The collected parking location information may include image data of at least one parking spot (e.g., an EV charge spot). The collected parking location information includes frequency data for parking at a predesignated electric vehicle charge spot. The collected parking location may also include frequency data for parking at a gasoline station or gasoline pump. The historical driving data may include vehicle driving range or historical parking information for the vehicle.

The electrical vehicle charge point location prediction may be utilized to control at least one of: a vehicle navigation system, a vehicle control system, a vehicle electronic control unit, or an autonomous vehicle control system associated with the EV. The electrical vehicle charge point location prediction may be generated as a probability score.

The collected real-time driving data, the retrieved historical driving data, and parking location information may also in some embodiments be provided to a machine learning (ML) model and the ML model may output one or more electrical vehicle charge point location prediction for the EV.

Some example embodiments disclosed herein provide a computer programmable product comprising a non-transitory computer-readable medium having stored thereon computer-executable instruction which when executed by one or more processors, cause the one or more processors to carry out operations for charging point location prediction.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a diagram of a charging point prediction system, in accordance with an example embodiment;

FIG. 2A illustrates a diagram of an apparatus for charging point location prediction, in accordance with an example embodiment;

FIG. 2B illustrates a diagram depicting communication of a map and positioning engine (MPE) with an infotainment unit of a vehicle, in accordance with one or more example embodiments;

FIG. 3 illustrates a diagram depicting steps for charging point location prediction for a vehicle, in accordance with an example embodiment;

FIG. 4 illustrates a flow chart of a method for charging point location prediction for a vehicle, in accordance with an example embodiment;

FIG. 5 illustrates a diagram of a parking lot wherein an embodiment of the presently disclosed method is utilized; and

FIG. 6 illustrates a diagram of a parking garage wherein an embodiment of the presently disclosed method is utilized for routing.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer-readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing devices.

As defined herein, a “computer-readable storage medium,” which refers to a non-transitory physical storage medium (for example, a volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no limiting effect.

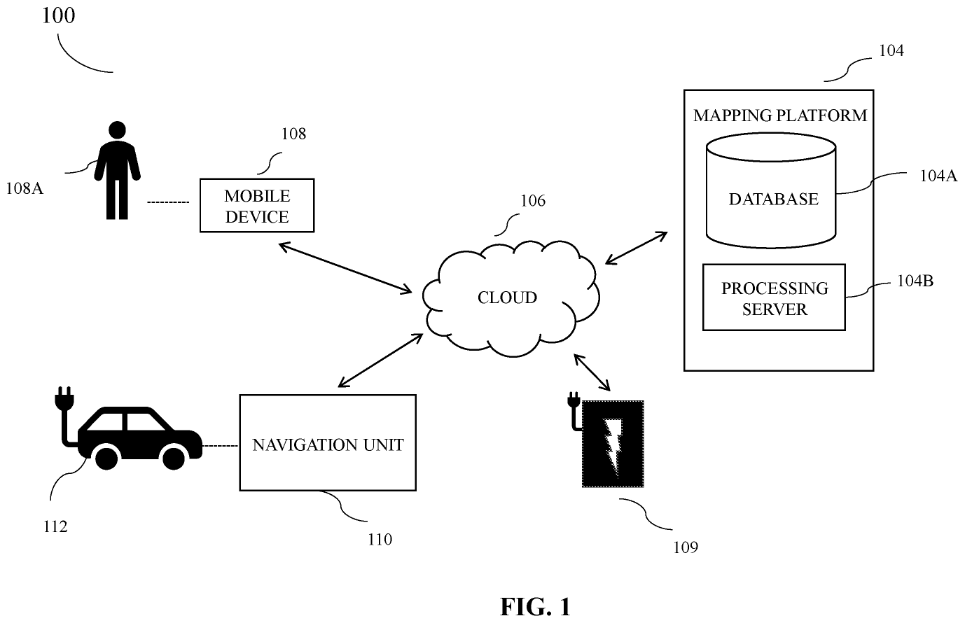

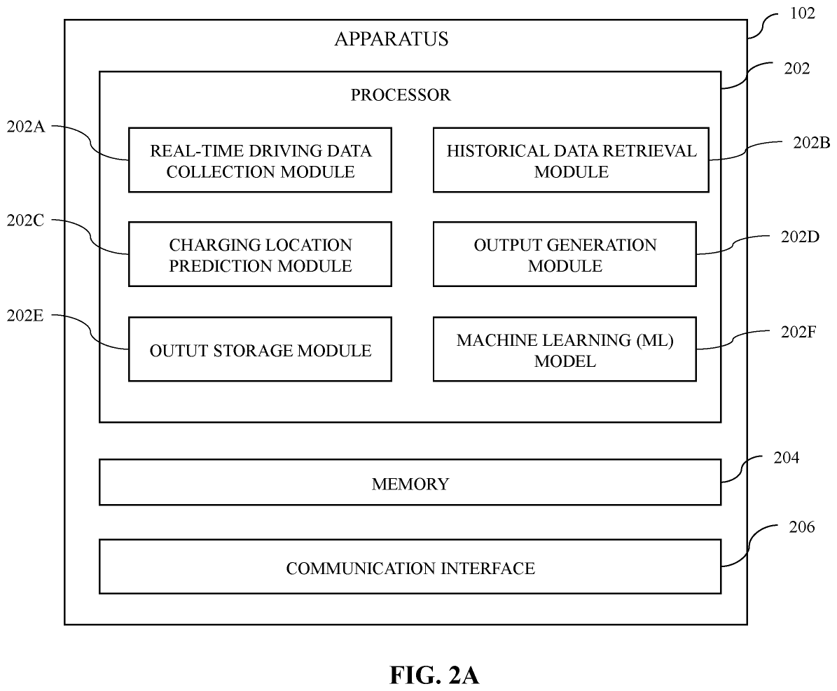

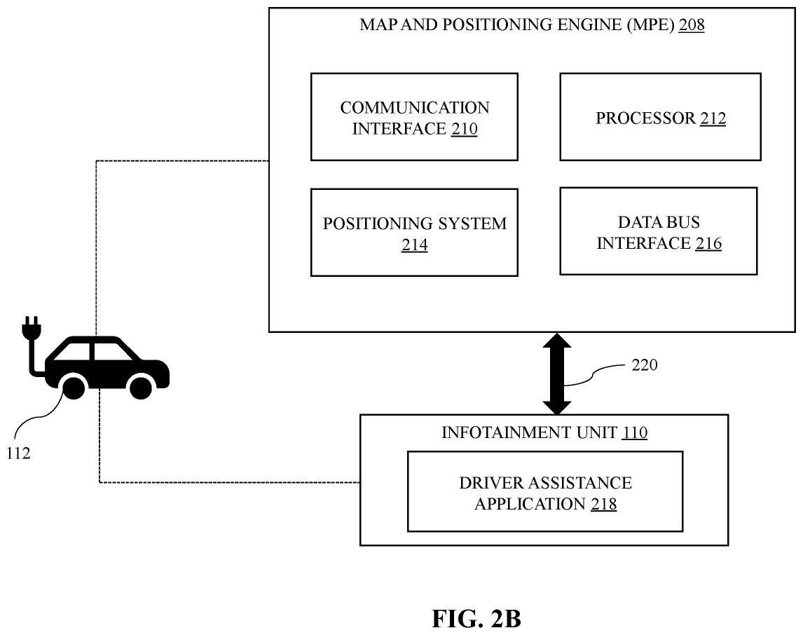

FIG. 1 provides an illustration of an example system 100 that can be used in conjunction with various embodiments of the present invention. As shown in FIG. 1, the system 100 may include an apparatus 102 (see FIG. 2) and a mapping platform 104 as well as end user devices, etc.

The apparatus 102 may be a stand-alone computer or a part of the other components listed in this application (e.g., smartphones, tablets, vehicle infotainment systems, etc.)

The mapping platform 104 may further include one or more databases 104A and a processing server 104B. The system 100 may further include a cloud 106 (e.g., a vehicle OEM or service provider hosted cloud), a mobile device 108 associated with a user 108A, an infotainment unit 110 of a vehicle 112, and a network 114. The components described as part of the system 100 may be further broken down into more than one component such as one or more sensors (e.g. cameras) or applications of the mobile device 108 or a vehicle 112 (in this case an EV) and/or combined in any suitable arrangement. Further, it is possible that one or more components of the system 100 may be rearranged, changed, added, and/or removed.

In an example embodiment the system 100 may be embodied as or associated with a cloud-based service or a cloud-based platform. In each of such embodiments, the apparatus 102 may be communicatively coupled to the components shown in FIG. 1 to carry out the desired operations and wherever required modifications may be possible within the scope of the present disclosure. As mentioned above the apparatus 102 may be implemented within a vehicle 112. Vehicle 112 may be a petrol fuel (e.g., gasoline or diesel) vehicle, hybrid, autonomous electric vehicle, a semi-autonomous electric vehicle, or a manually driven electric vehicle, etc. Infotainment unit 110 may also be integrated with the vehicle 112. The infotainment unit 110 may be utilized by the user 108A to access various applications, such as navigation applications, entertainment applications, and so forth. Further, in one embodiment, the apparatus 102 may be a standalone unit configured to generate a charging point, kiosk, station, etc. location prediction and then further recommending one or more charging points to the user 108A for charging an electric vehicle. In an embodiment, user 108A may be a driver or a passenger of vehicle 112. Alternatively, apparatus 102 may be embodied within an external device such as vehicle 112 or the mobile device 108. Additionally, mobile device 108 may be associated, coupled, or otherwise integrated within vehicle 112, such as within the vehicle's head unit, infotainment unit, or an advanced driver assistance system (ADAS). All the functionalities may be run upon one device such as an EV, mobile device, etc. or utilize multiple of these devices for a distributed solution.

In some example embodiments, the apparatus 102 may be any user-accessible device such as a mobile phone, a smartphone, a portable computer, and the like or as a part of another portable/mobile object such as the vehicle 112. The apparatus 102 may comprise a processor, a memory, and a communication interface. The processor, the memory, and the communication interface may be communicatively coupled to each other. In some example embodiments, the apparatus 102 may be associated, coupled, or otherwise integrated with the vehicle 112 of the user 108A, such as an advanced driver assistance system (ADAS), a personal navigation device (PND), a portable navigation device, infotainment unit 110 and/or other device that may be configured to provide route guidance and navigation related functions to the user 108A. In such example embodiments, the apparatus 102 may comprise a processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, one or more cameras, and other components as may be required for specific functionalities of the apparatus 102. Additional, different, or fewer components may be provided. For example, the apparatus 102 may be configured to execute and run mobile applications such as a messaging application, a browser application, a navigation application, and the like.

In some other embodiments, the system 100 may feature an apparatus 102 that may communicate with or, in some cases, be part of a cloud computing solution such as a hosted cloud (cloud 106). The cloud 106 may be configured to anonymize data received from the apparatus 102, as needed before using the data for further processing. In some embodiments, anonymization of data may also be done by the mapping platform 104. In some embodiments, the cloud 106 may include a server and a database configured to receive various forms of probe data from vehicles or devices. These servers and databases may be the same utilized by the mapping platform 104 or separate pieces of infrastructure.

The probe data may be used by the system 100 to generate and predict charging location information for a given charge point. Such data may be supplied or supplemented by data from a mobile device to generate independent location-based services or other entities may participate and contribute in the same manner as described herein through data integration, etc.

The system 100 may provide aggregated mobility data from a plurality of probes or devices associated with a respective charge point. The system may use this data for predicting charge point location and utilization (real-time or otherwise). For example, the system may provide probe data points including location (e.g., latitude and longitude or a map-matched location) and a typical driving range of a vehicle. Such information can provide insight into locations where vehicles typically park at the end of their normal driving range and could thus indicate the location of an EV charger.

The system 100 may further provide other information for individual vehicles. For example, in some embodiments, data on parking location(s) and parking time for a vehicle (both real time and historical) may be observed by use of vehicle location data, accelerometers, etc. Metadata about the parking location(s) may also be recorded such as nearby POIs, other vehicles parked nearby, etc.

In other embodiments, the system 100 may observe other data available from a given vehicle's internal systems such as battery charge level (e.g., at the start and at the end of charging) can be used to determine what charge needs a vehicle may have, how long it may need to charge, and what data might be obtained from a charge point. This charge point location information may be used for vehicle routing, civic planning, prediction of other charge point locations, etc.

In FIG. 1, a charge point 109 is shown. This point may represent any public or private charge point. The availability of this charge point may vary over time and its exact output, ability to service multiple vehicles, etc. may be observed and/or predicted by the present system 100.

Information pertaining to vehicles may be received from an OEM, other service providers, etc. and may include vehicle specifics, such as fuel type, battery capacity, charging type (e.g., connector, charge compatibility), etc. Vehicle information may also include sensor data, which can include trajectory information (e.g. an origin and destination), a battery charge level at the beginning and end of a trajectory or drive, home charging events (e.g., including duration, energy delivered, time, battery levels), parking events, etc.

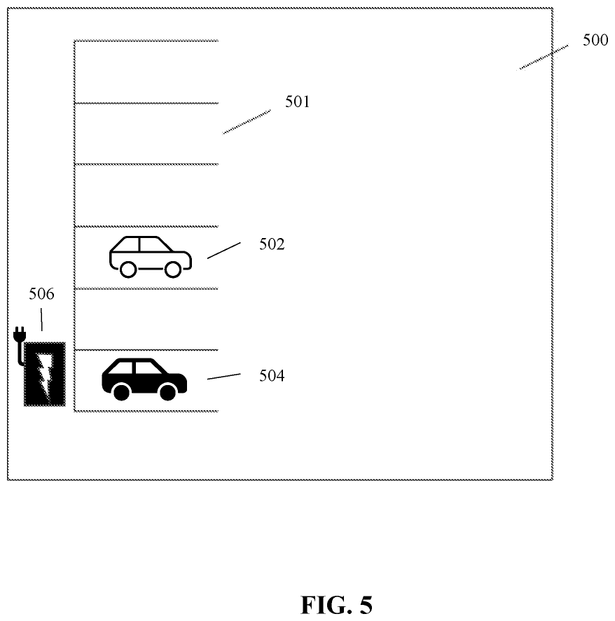

According to some embodiments, other data utilized by the system 100 and/or the apparatus 102 may include data from a charge point service provider or a charge point information service. Charge point service providers (e.g., a power company) or a charge point information service (e.g., a charge point finder application) may be sources of rich data that can inform on charge point utilization, state-of-charge of vehicles that use the charge points, historical charge point information (e.g., price, utilization, daily/weekly/seasonal fluctuations, etc.), and other information associated with charge points that can be used to train a machine learning model capable of predicting charge point location(s) at a given location. The sharing of such information is shown in FIG. 1, wherein the charge point 109 is also shown sharing information with the cloud 106. This is a non-limiting example, and it is fully envisioned the system 100 may in some embodiments generate predictions for charging point locations based solely on vehicle parking information, driving patterns, etc. (see FIG. 5).

It is also fully envisioned that in some cases the charge point operator may not share some or all of the charging information data collected by the charge point 109. In such a situation, data from an end user mobile device 108 or data from the infotainment unit 110 of a vehicle 112 may be leveraged in combination with or as part of probe data and/or crowdsourced data provided to the system 100. This data may then be used to determine or predict charging infrastructure location and availability. In this example, the data from the mobile device 108, charge point 109, and infotainment system 110 are made available to the mapping platform 104.

The mapping platform 104 may comprise the one or more databases 104A for storing map data and the processing server 104B. The one or more databases 104A may include data associated with one or more of a road signs, road condition information, speed signs, or road objects on a link or path. Further, the one or more databases 104A may store charging data, accident data, node data, road segment data, link data, point of interest (POI) data, link identification information, heading value records, or the like. Also, the one or more databases 104A further include speed limit data of each lane, cartographic data, routing data, and/or maneuvering data. Additionally, the one or more databases 104A may be updated dynamically to accumulate real-time traffic conditions based on prediction of vehicle charging location(s).

The real-time traffic conditions may be collected by analyzing the location transmitted to the mapping platform 104 by a one or more (or a large number) of users. In one example, by calculating the speed of the road users along a length of road, the mapping platform 104 may generate a live traffic map, which is stored in the one or more databases 104A in the form of real-time traffic conditions based in part on prediction of vehicle charger location. In one embodiment, the one or more databases 104A may further store historical traffic data that includes routing data, travel times, areas where charging issues are prone to occur, areas with the minimum and maximum charging needs, average speeds and probe counts on each road or area at any given time of the day and any day of the year.

According to some example embodiments, the road segment data records may be links or segments representing roads, streets, or paths, as may be used in calculating a route or recorded route information for determination of one or more personalized routes to enable guidance to an EV charger. The node data may be ending points corresponding to the respective links or segments of road segment data. The road link data and the node data may represent a road network used by vehicles such as cars, trucks, buses, motorcycles, and/or other entities. Optionally, the one or more databases 104A may contain path segment and node data records, such as shape points or other data that may represent pedestrian paths, links, or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as charging stations, gasoline stations, hotels, restaurants, museums, stadiums, offices, parking lots, auto repair shops, buildings, stores, parks, etc.

The one or more databases 104A may also store data about the POIs and their respective locations in the POI records. The one or more databases 104A may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the one or more databases 104A may include event data (e.g., traffic incidents, construction activities, scheduled events, unscheduled events, vehicle accidents, diversions, etc.) associated with the POI data records or other records of the one or more databases 104A associated with the mapping platform 104. Optionally, the one or more databases 104A may contain path segment and node data records or other data that may represent pedestrian paths or areas in addition to or instead of the autonomous vehicle road record data. In an embodiment, one or more databases 104A may be a source-available document-oriented database. The POI records may also contain an indicator that a given POI does or does not have a charging station as metadata/an attribute of a given POI. It should also be noted the in some examples a POI may be something like a single EV charge point, a larger charging station, hospital, restaurant, park, school, bus stop, etc. Relevant POIs for a given use case may be defined, either manually or automatically, by reference to a map database and identification of a POI and its various attributes in image data captured by a camera system. The location of POIs may be found by GPS coordinates or any other functionally capable means.

The one or more databases 104A may also store data about map objects. One example of a map object is a bridge, and another example of a map object is a railroad crossing or median. A wide variety of other map objects may exist including, for example, walls/fences, manhole covers, transitions between different types of road surfaces, medians, parking meters, various forms of infrastructure, or the like.

In some embodiments, the one or more databases 104A may be a master map database stored in a format that facilitates updating, maintenance, and development. For example, the master map database or data in the master map database may be in any suitable spatial format, such as for development or production purposes. The spatial format or development/production database may be compiled into a delivery format, such as a geographic data files (GDF) format. The data in the production and/or delivery formats may be compiled or further compiled to form geographic database products or databases, which may be used in end-user navigation devices or systems.

For example, geographic data may be compiled (such as into a platform specification format (PSF) format) to organize and/or configure the data for performing navigation-related functions and/or services in an event of a predicted vehicle's charging needs, such as route calculation, route guidance, map display, speed calculation, distance and travel time functions, and other functions, by a navigation device, such as by the apparatus 102 or by the mobile device 108. The navigation-related functions may correspond to vehicle navigation, pedestrian navigation, or other types of navigation to avoid a zone where the vehicle accident has been predicted by the apparatus 102. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the one or more databases 104A may be a master geographic database, but in alternate embodiments, the one or more databases 104A may be embodied as a client-side map database and may represent a compiled navigation database that may be used in the apparatus 102 to provide navigation and/or map-related functions in an event of a predicted vehicle's charging event or needs. For example, the one or more databases 104A may be used with the apparatus 102 to provide an end user with navigation features. In such a case, the one or more databases 104A may be downloaded or stored locally (cached) on the apparatus 102. As mentioned above, the apparatus 102 may be contained within a smartphone or in-car navigation system allowing users to access the system 100 on the go.

The processing server 104B may comprise processing means, and communication means. For example, the processing means may comprise one or more processors configured to process requests received from the apparatus 102. The processing means may fetch map data from the one or more databases 104A and transmit the same to the apparatus 102 via the cloud 106 in a format suitable for use by the apparatus 102. In one or more example embodiments, the mapping platform 104 may periodically communicate with the apparatus 102 via the processing server 104B to update a local cache of the map data stored on the apparatus 102. Accordingly, in some example embodiments, the map data may also be stored on the apparatus 102 and may be updated based on periodic communication with the mapping platform 104. In some embodiments, the map data may also be stored on the mobile device 108 and may be updated based on periodic communication with the mapping platform 104 including the processing server 104.

The processing server 104B may receive probe data, directly or indirectly, from a mobile device 108, such as when the mapping platform 104 is also functioning as, or part of, the cloud 106.

The mobile device 108 may include one or more detectors or sensors that act as a positioning system built or embedded into or within the device. Alternatively, the mobile device 108 may use communications signals for position determination. The mobile device 108 may receive location data from a positioning system, such as a Global Navigation Satellite System (GNSS) like the global positioning system (GPS) Galileo, etc., cellular tower location methods, access point communication fingerprinting, or the like. The processing server 104B, either directly or indirectly, may receive sensor data configured to describe a position of a mobile device, or a controller of the mobile device 108 may receive the sensor data from the positioning system of the mobile device 108. The mobile device 108 may also include a system for tracking mobile device movement, such as rotation, velocity, or acceleration. Movement information may also be determined using the positioning system. The mobile device 108 may use the detectors and sensors to provide data indicating a location of a vehicle. This vehicle data, also referred to herein as part of the probe data, may be collected by any device capable of determining the necessary information, and providing the necessary information to a remote server or other entity. The mobile device 108 is one example of a device that can function as a probe to collect probe data of a vehicle.

More specifically, probe data (e.g., collected by mobile device 108) may be representative of the location of a vehicle at a respective point in time and may be collected while a vehicle is traveling along a route, at the origin of the route, a destination (e.g., parking location), or waypoints along the route. Probe data of some example embodiments may include parking location and status of a vehicle. According to the example embodiment described below with the probe data being related to a motorized vehicle traveling along roadways, the probe data may include, without limitation, location data, (e.g. a latitudinal, longitudinal position, and/or height, GNSS coordinates, proximity readings associated with a radio frequency identification (RFID) tag, or the like), rate of travel, (e.g. speed), direction of travel, (e.g. heading, cardinal direction, or the like), device identifier, (e.g. vehicle identifier, user identifier, or the like), a time stamp associated with the data collection, or the like. The mobile device 108, may be any device capable of collecting the aforementioned probe data. Some examples of the mobile device 108 may include specialized vehicle mapping equipment, navigational systems, mobile devices such as phones or tablets, or the like.

Further, this probe data may include battery charge level or other contextual information about a source of the probe data that may provide inputs to the mapping platform 104 for establishing where an EV charge point would be most likely located. This data may be collected by mobile device 108 by tracking vehicle movement over time via device accelerometer, etc. to estimate where and how long a given vehicle is parked at a given location. This data may be combined with information such as battery charge level to infer if a given vehicle is an EV and if said EV is parked at a charging location.

For example, the mobile device may infer a charge has occurred by the lack of movement of a mobile device located within a vehicle. The mobile device (acting as or part of the system 100) may automatically or manually detect movement above a certain threshold (e.g., 30 mph) as an indication that the mobile device is being driven within a vehicle. Using the map data mentioned above and specifically the data which indicates the location of charge point 109, the system 100 may deduce that a vehicle has driven to a charge point and is parked close to said charge point either charging or waiting to charge.

In some example embodiments, the mobile device 108 may be any user-accessible device such as a mobile phone, a smartphone, tablet, a portable computer, and the like associated with the user 108A. The mobile device 108 may comprise a processor, a memory, and a communication interface. The processor, the memory and the communication interface may be communicatively coupled to each other. In some example embodiments, the mobile device 108 may be associated, coupled, or otherwise integrated with the vehicle 112 of the user 108A, such as an advanced driver assistance system (ADAS), a personal navigation device (PND), a portable navigation device, the infotainment unit 110 and/or other device that may be configured to provide route guidance and navigation related functions to the user 108A. In such example embodiments, the mobile device 108 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the mobile device 108. Additional, different, or fewer components may be provided. In one embodiment, the mobile device 108 may be directly coupled to the apparatus 102 via a communications network. In some example embodiments, at least one user equipment such as the mobile device 108 may be coupled to the apparatus 102 via the cloud 106 and one or more communications networks. For example, the apparatus 102 may be part of a consumer vehicle or an end user device. In some example embodiments, the mobile device 108 may serve the dual purpose of a data gatherer and a beneficiary device. This is also true of the vehicle infotainment unit 110. The mobile device 108 and/or infotainment unit may be configured to capture the sensor data associated with a road on which the vehicle 112 may be traversing. The sensor data may, for example, be image data of road objects, road signs, charge points, parking signs, or the surroundings. The sensor data may refer to sensor data collected from a sensor unit in the mobile device 108. In accordance with an embodiment, the sensor data may refer to the data captured by any vehicle using sensors. The mobile device 108 may be communicatively coupled to the apparatus 102, the mapping platform 104, the infotainment unit 110 and the cloud 106 over a network.

The network may be wired, wireless, or any combination of wired and wireless communication networks, such as cellular, Wi-Fi, internet, local area networks, or the like. In one embodiment, the network may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. For example, the mapping platform 104 may be integrated into a single platform to provide a suite of mapping and navigation-related applications for OEM devices, such as the user devices and the apparatus 102. The apparatus 102 may be configured to communicate with the mapping platform 104 over the network. Thus, the mapping platform 104 may enable the provision of cloud-based services for the apparatus 102. Personal area networks such as Bluetooth, IrDA, ZigBee, etc. may also be utilized in some embodiments.

In operation, the vehicle 112 may require petrol fuel (gasoline, diesel, ethanol, etc.), hydrogen, or electrical charging at some point. In such a case, the apparatus 102 may recognize the need. In an example embodiment, the mobile device 108 or the infotainment unit 110 may be utilized by the user 108A to transmit a trigger to the apparatus 102 to receive the prediction of one or more charging points for the vehicle 112 (if needed). Based on the recognition of the charge need, the apparatus 102 may be configured to collect real-time charging data from the infotainment unit 110 of the vehicle 112 or the mobile device 108.

In some embodiments the infotainment unit 110 may be connected to the mobile device 108. When the communication between the mobile device 108 and the infotainment unit 110 is absent, the apparatus 102 may collect data for the vehicle 112 from the mobile device 108 and/or infotainment unit independently. It is fully envisioned that in some cases the system 100 may function only on mobile device data or infotainment system data (and not both simultaneously).

In some embodiments, the collected real-time charging data may include at least information for the vehicle 112 and the charge point 109 information. The EV charge point information may include information associated with one or more charging points that may have their location predicted/recommended by the apparatus 102. It should be noted that the infotainment unit may be configured to communicate with a controller area network (CAN) bus of the EV to receive the real-time charging data and information on a given charge point.

In another embodiment, the collected real-time charging data may include at least one of: location information, a temperature at a current location, battery capacity, current battery level, connection information associated with at least one charging port of an EV, an instantaneous charge rate of an EV, a range of an EV remaining at a current time instance, a current charging event associated with the location of an EV, and occupancy information of the charging points associated with the location of the charging EV.

The apparatus 102 may further retrieve historical charging data associated with from the one or more databases 104A. The historical charging data may include compatible EV connector data, EV make or model data, EV model year or age data, or data associated with previous charging sessions of the EV.

FIG. 2A illustrates an apparatus 102 for charging point location prediction, in accordance with an example embodiment. FIG. 2A is explained in conjunction with elements of FIG. 1. The apparatus 102 may include a processing means such as at least one processor 202 (hereinafter, also referred to as “processor 202”), storage means such as at least one memory 204 (hereinafter, also referred to as “memory 204”), and a communication means such as at least one communication interface 206 (hereinafter, also referred to as “communication interface 206”). The processor 202 may further include one or more processing modules, such as a real-time driving data collection module 202A, a historical data retrieval module 202B, a charging location prediction module 202C, an output generation module 202D, an output storage module 202E and an ML model 202F. The processor 202 may retrieve computer program code instructions that may be stored in the memory 204 for execution of the computer program code instructions.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading.

In some embodiments, the processor 202 may be configured to provide Internet-of-Things (IoT) related capabilities to the user 108A of the apparatus 102. The IoT related capabilities may in turn be used to provide charging station recommendation solutions, smart navigation solutions, and hazard warnings by providing real-time updates to the users to take pro-active decision on turn-maneuvers, lane changes, overtaking, merging, and the like, big data analysis, and sensor-based data collection by using the cloud-based mapping system for providing navigation recommendation services to the users. The apparatus 102 may be accessed using the communication interface 206. The communication interface 206 may provide an interface for accessing various features and data stored in the apparatus 102.

Additionally, or alternatively, the processor 202 may include one or more processors capable of processing large volumes of workloads and operations to provide support for big data analysis. In an example embodiment, the processor 202 may be in communication with the memory 204 via a bus for passing information among components coupled to the apparatus 102.

The real-time driving data collection module 202A may be configured to collect the real-time driving data for the vehicle 112 from the mobile device 108 or the infotainment unit 110.

In an embodiment, the mobile device 108 may be separate from the vehicle 112. In that scenario, the mobile device 108 may be an additional mobile device that serves as a crowdsourcing contributor device for providing data to the mapping platform 104 about routing, parking spots, etc. However, when the mobile device 108 is coupled to the vehicle 112, then may also help to collect real-time data for the vehicle 112.

The collected real-time driving data may include at least travel information for the vehicle 112 and parking information. For example, the real-time driving data collection module 202A may communicate with the mobile device 108 or the infotainment unit 110 in real-time or near real-time via the network 114.

The historical driving data retrieval module 202B may be configured to retrieve the historical data associated with the vehicle 112 from the one or more databases 104A. For example, the historical data retrieval module 202B may communicate with the one or more databases 104A via the network 114 to retrieve a profile of the vehicle 112. The vehicle 112 may have a profile which features normal driving distance for the vehicle, typical parking location(s), etc.

The charging location prediction module 202C may be configured to generate the charging location prediction based on the collected real-time data, the retrieved historical data, and other data such as existing EV charge point information. The charge point location prediction may, in some embodiments, be a prediction of a parking spot suitable for charging an EV. This prediction may be based on the factors mentioned above and others.

For example, the prediction of the charging point location may be done by the use of the machine learning model 202F that has been previously trained on stored aggregated historical data of numerous vehicles and is able to output a prediction. In this example, the output may be labeling or identifying a previously unknown charging location within a map database when electric vehicles park in a given area for a statistically significant amount of time. Such aggregation may be location specific for a given street, block, neighborhood, town, city, parking lot, parking garage, etc. depending on the level of granularity and map resolution required.

The charging location prediction module 202C may also be configured to process the collected real-time data and the retrieved historical data to generate the charging location prediction associated with a certain parking spot or spots in some embodiments. The ML model 202F and charging location prediction module 202C may also work in tandem to provide greater accuracy, efficiency, and/or expedient results.

The output generation module 202D may be configured to generate an output based on the charging location prediction. The output may be associated with one or more parking spots which also serve as charging points for EVs. For example, the output generation module 202D may process the charging location prediction to generate the output for a single end user 108A. The processor may generate an alert message on a display interface of the apparatus 102 or the mobile device 108 that a given EV battery is depleted, charging needed soon, etc. Further, the display interface may also display a map and show location of the most suitable charge point(s) in vicinity of the EV. At least one of these charge points may be a predicted charge point, the location of which is inferred by the apparatus 102 based on aggregated data of other EV's driving and parking patterns.

For example, EV drivers may typically drive past a known charging location and instead travel half a block down the road to park for 30 min at a public library. This list of factors: EVs present, parked for 30 minutes at a time, parked in same area by a public institution (the library) can be used to predict that there is likely a previously unknown (to the apparatus 102) charge point location. In some examples, this prediction may be given a score out of 100, the score being modulated or adjusted up and down based on various weighted factors. In this example, the EVs driving past a paid charger to park nearby may be a strong indication that there is a free or lower cost charge point present at the library location. This additional factor may be used to boost the prediction score. The prediction score may itself be used as a threshold for alerts, routing, etc. For example, a score of 60/100 may be required to route end users to a newly predicted charge point location. Other factors, such as gasoline powered cars parking at a given location may reduce the above score since their presence would suggest a given parking location is not meant for EV charging.

It should be noted that the system 100, apparatus 102, etc. may also be configured to suggest predicted charge point locations which are most suitable for an end user. Put another way, metadata about the charge point may also be inferred in some embodiments. For example the cheapest charge point to use in a given area, fastest, located close to certain POIs, etc.

The output storage module 202E may be configured to store the charging location prediction or the output in the one or more databases 104A. For example, the output storage module 202E may communicate with the one or more databases 104A via the network 114 to transmit the prediction or the output to the one or more databases 104A.

In some embodiments, the ML model 202F is embodied outside the processor 202, and the representation shown in FIG. 2A is for exemplary purposes only. The ML model 202F may provide the necessary intelligence needed by the apparatus 102 for generation of the prediction.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus to carry out various functions in accordance with an example embodiment of the present invention. For example, the memory 204 may be configured to buffer input data for processing by the processor 202. As exemplarily illustrated in FIG. 2A, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present invention while configured accordingly. Thus, for example, when the processor 202 is embodied as an ASIC, FPGA or the like, the processor 202 may be specifically configured hardware for conducting the operations described herein. Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present invention by further configuration of the processor 202 by instructions for performing the algorithms and/or operations described herein. The processor 202 may include, among other things, a clock, an arithmetic logic unit (ALU) and logic gates configured to support operation of the processor 202.

The communication interface 206 may comprise input interface and output interface for supporting communications to and from the apparatus 102 or any other component with which the apparatus 102 may communicate. The communication interface 206 may be any means such as a device or circuitry embodied in either hardware or a combination of hardware and software that is configured to receive and/or transmit data to/from a communications device in communication with the apparatus 102. In this regard, the communication interface 206 may include, for example, an antenna (or multiple antennae) and supporting hardware and/or software for enabling communications with a wireless communication network. Additionally, or alternatively, the communication interface 206 may include the circuitry for interacting with the antenna(s) to cause transmission of signals via the antenna(s) or to handle receipt of signals received via the antenna(s). In some environments, the communication interface 206 may alternatively or additionally support wired communication. As such, for example, the communication interface 206 may include a communication modem and/or other hardware and/or software for supporting communication via cable, digital subscriber line (DSL), universal serial bus (USB) or other mechanisms. In some embodiments, the communication interface 206 may enable communication with a cloud-based network to enable deep learning.

FIG. 2B illustrates a block diagram depicting communication of a map and positioning engine (MPE) 208 with the infotainment unit 110 of the vehicle 112, in accordance with one or more example embodiments. FIG. 2B is explained in conjunction with elements of FIG. 1 and FIG. 2A. The block diagram represents a map-enhanced Advanced Driver Assistance Systems (ADAS) architecture. The block diagram includes the MPE 208. The MPE 208 may further include a communication interface 210, a processor 212, a positioning system 214 and a data bus interface 216. The block diagram may further include the infotainment unit 110 that may communicate with a driver assistance application 218 or the driver assistance application 218 may be integrated with the infotainment unit 110 of a vehicle 112.

The MPE 208 may be a standalone module, however, it is understood that the MPE 208 may be distributed into multiple packages and/or integrated into other devices, such as a sensor package of a vehicle. The MPE 208 may also include other hardware, software, and/or firmware, such as memory and a power source.

In an embodiment, the processor 212 may be same as the processor 202. The processor 212 may be any type of processor, controller, or other computing device. For example, the processor 212 may be a digital signal processor. The processor 212 receives inputs from the positioning system 214, the communication interface 210, the data bus interface 216, and other sources such as a geographic database. For example, the geographic database may be the one or more databases 104A. In some embodiments, the one or more databases 104A may be a part of the MPE 208. The processor 212 then processes the inputs using one or more application software programs.

The processor 212 may then provide outputs to the driver assistance applications via the data bus interface 216 which may be an in-vehicle data bus interface and a data bus 220. Preferably, the data bus interface 216 and the data bus 220 may be a Controller-Area Network (CAN) interface and a CAN-bus, that may be designed for automotive applications. The driver assistance applications 218 may include navigation applications, adaptive headlight aiming, adaptive cruise control, obstruction detection, obstruction avoidance, collision avoidance, adaptive shift control, entertainment applications such as audio and video and so forth.

In some embodiments, the CAN bus may collect data from various car sensors and provide this data to the mapping platform 104 for further analysis and processing. The collected data includes things such as battery capacity of the vehicle in watt-hours (Wh), EV battery level in watt-hours (Wh), list of EV Connector Types the vehicle may use, EV charge port connected/EV charge port open, EV instantaneous charge rate in milliwatts, range remaining in meters, car details, manufacturer of vehicle, model of vehicle, model year of vehicle, and the like. This collected data may be transmitted by the communication interface 210 to the mapping platform 104.

In some embodiments, the communication interface 210 may be same as the communication interface 206 explained in FIG. 2A or the two interfaces may operate separately, and both conduct various forms of communication for the system 100, apparatus 102, etc.

The positioning system 214 may utilize Global Positioning System (GPS) or GNSS type technology, a dead reckoning-type system, or combinations of these or other systems, all of which are known in the art. The positioning system 214 may also include suitable sensing devices that may measure a traveling distance speed, direction, orientation, and so on. For example, the positioning system 214 may include a GPS system and a gyroscope. The positioning system 214 may provide an output signal to the processor 212. Some of the application software programs that run on the processor 212 use the output signal from the positioning system 214 to determine a location, direction, orientation, etc., of the MPE 208. The mapping platform 104 further processes the data for providing charging point recommendation for the vehicle 112.

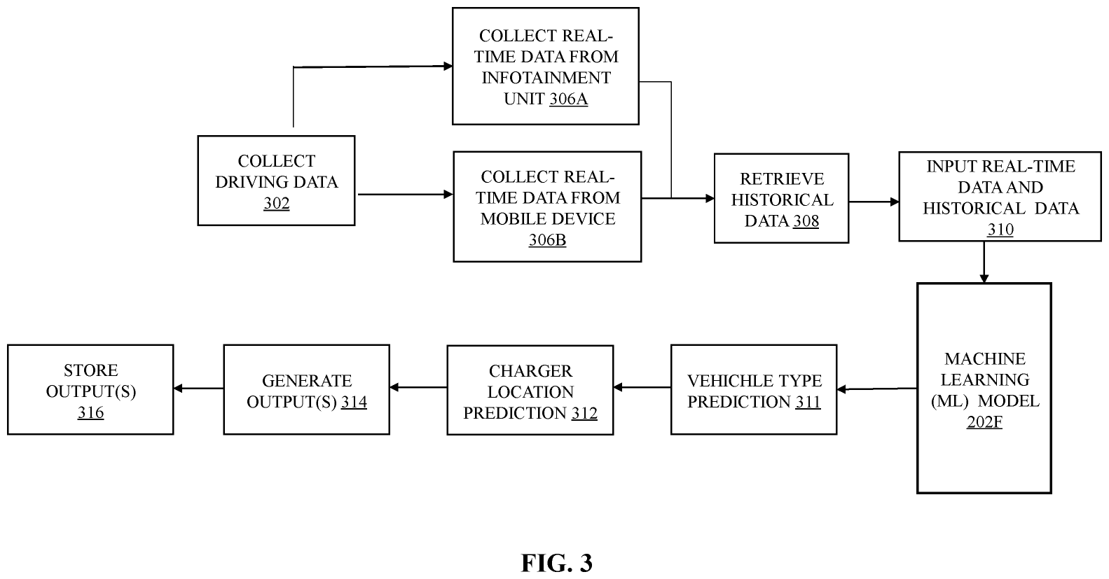

FIG. 3 is a flow chart depicting steps of a method for providing charging point recommendation for a vehicle 112, in accordance with an example embodiment. FIG. 3 is explained in conjunction with elements of FIG. 1, FIG. 2A and FIG. 2B. It will be understood that each block/step of the diagram 300 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 204 of the apparatus 102, employing an embodiment of the present invention and executed by the processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flow diagram blocks.

It will also be understood that one or more blocks of the flow chart, and combinations of blocks in the flow diagram, may be implemented by special purpose hardware-based computer systems which perform the specified functions, or combinations of special purpose hardware and computer instructions. Fewer, more, or different steps may be provided.

At step 302, an input or indication regarding driving a car, truck, etc. may be received. In an embodiment, the processor 202 may be configured to receive input regarding the driving of the vehicle 112. The driving data may be received from the mobile device 108 associated with the user 108A of the vehicle 112. In another embodiment, the driving data may be received from the infotainment unit 110. The driving data may include but is not limited to routing information, parking information, etc.

At step 306A, real-time driving data may be collected. In an embodiment, a processor 202 may be configured to collect the real-time charging data from the infotainment unit 110 of the vehicle 112. The real-time data may also be collected from the infotainment unit 110 and the mobile device 118 (step 306B). In some embodiments, mobile device may be connected to the infotainment unit 110 and communicate information between the two via any functional data connection (USB, Bluetooth, etc.). The collected real-time driving data may also include parking information for a vehicle.

As discussed above, EV charge point information may be collected or predicted based on a single vehicle's driving data or based upon aggregated driving data for multiple vehicles some of which are EVs and some of which may be hybrid, hydrogen, or gasoline powered. In an embodiment, the infotainment unit 110 may be configured to communicate with a controller area network (CAN) bus of an EV to receive charging data. The collected charging data may include, but is not limited to, a battery capacity in watt-hours (Wh), a battery level in watt-hours (Wh), the types of connectors used, an instantaneous charge rate in milliwatts, a remaining driving range, and the like.

In another embodiment, it may be the case that data from the infotainment unit 110 and/or mobile device 108 is not available. For example, there may be a lack of network connectivity for one of these system devices. In such a case the real-time charging data may be collected upon a mobile device 108 or infotainment device 110 and communicated to the cloud, servers, etc. independently when network connectivity is established. With this in mind, the mobile device 108 may be associated with the user 108A of the vehicle 112 or the mobile device 108 may also be an additional mobile device associated with a passenger of a vehicle 112 or a user of a different vehicle. The mobile device data may even be supplied by a device outside of any vehicle, meaning crowdsourced from pedestrians, etc. One such example could be collecting data on charge point locations and occupancy by pedestrians or bikers traveling in a given area.

At step 308, historical driving data may be retrieved. In an embodiment, the processor 202 may be configured to retrieve historical data associated with the vehicle 112 from the one or more databases 104A. The retrieved historical data may include, but is not limited to routing information, driving patterns, parking locations, parking times, etc.

The historical data might also include end user preferences. For example, if an end user typically parks at only free charging stations, this information may be used to by the system to generate metadata for a charging location prediction. In such a situation, if there are multiple charge points 109 in an area and the end user choses to park at a location over the other charge points, it could be inferred that this charge point is low cost or no cost compared to the other charge points.

Other historical data might include EV connector data which may encompass various aspects and details about EV connectors such as, but not limited to, connector types and standards, connector compatibility, charging speeds, connector pinout, voltage and current ratings, connector design and physical specifications, safety features, regional variations, charging infrastructure data, and connector manufacturers.

Information such as EV make or model data may also be captured or predicted by some embodiment of the presently disclosed system 100, etc. Such data might include: a make and model of the EV, a name of the manufacturer of the EV, a stock battery capacity of the EV, and the like. The EV model year or age data may also be used by the system. Data associated with previous charging sessions of an EV may refer to information and records related to one or more historical charging activities of an EV and may include, but is not limited to, a charging session timestamp, a charging duration, a charging station location, a charging connector information, an energy consumption, a charging power level, a charging cost, and the like. This data may be obtained by any functionally relevant means including communication with a vehicle's internal processors, etc. This data may also be predicted based on driving and parking data (see step 311). The observed or predicted data may be stored in a profile for each vehicle for use in aggregation, etc.

At step 310, the collected real-time data and the retrieved historical data may be provided as an input to the ML model 202F.

The ML model 202F may be one or more computational network or a system of artificial neurons, arranged in a plurality of layers, as nodes. The plurality of layers of the ML model may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the ML model. Outputs of each hidden layer may be coupled to inputs of at least one node in other layers of the ML model 202F. Node(s) in the final layer may receive inputs from at least one hidden layer to output a result. The number of layers and the number of nodes in each layer may be determined from hyper-parameters of the ML model. Such hyper-parameters may be set before or while training the ML model on a training dataset.

Each node of the ML model may correspond to a mathematical function (e.g., a sigmoid function or a rectified linear unit) with a set of parameters, tunable during training of the ML model. The set of parameters may include, for example, a weight parameter, a regularization parameter, and the like. Each node may use the mathematical function to compute an output based on one or more inputs from nodes in other layer(s) (e.g., previous layer(s)) of the ML model). All or some of the nodes of the ML model may correspond to same or a different mathematical function.

In training of the ML model, one or more parameters of each node of the ML model may be updated based on whether an output of the final layer for a given input (from the training dataset) matches a correct result based on a loss function for the ML model. The above process may be repeated for the same or a different input until a minimal of loss function may be achieved, and a training error may be minimized. Several methods for training are known in art, for example, gradient descent, stochastic gradient descent, batch gradient descent, gradient boost, meta-heuristics, and the like.

In context of the present disclosure, the ML model 202F may be the trained on a historical training dataset that may be associated with a vehicle 112. Specifically, the historical training dataset may include historical driving data associated with one or more vehicles. As discussed above, this data may include routing information, driving patterns, and/or parking information. This data might also include historical charging data may in turn include compatible EV connector data, EV make or model data, EV model year or age data, or data associated with previous charging sessions of a given EV. The ML model may learn patterns and knowledge from the historical training dataset to make predictions or decisions on new, incoming data. Details about the application of the ML model are provided below.

The ML model may include electronic data, such as, for example, a software program, code of the software program, libraries, applications, scripts, or other logic or instructions for execution by a processing device, such as circuitry. The ML model may include code and routines configured to enable a computing device, such as the apparatus 102 to perform one or more operations. Additionally, or alternatively, the ML model 202F may be implemented using hardware including a processor, a microprocessor (e.g., to perform or control performance of one or more operations), a field-programmable gate array (FPGA), or an application-specific integrated circuit (ASIC). Alternatively, in some embodiments, the ML model 202F may be implemented using a combination of hardware and software.

The processor 202 may be configured to provide the collected real-time driving and parking data as well as the retrieved historical data, as an input, to the ML model. The ML model may be a pre-trained model that may be further trained on the dataset containing stored and/or real-time charging data to output the prediction(s) as discussed above and below.

At step 311, a vehicle type prediction may be generated. In an embodiment, the processor 202 may be configured to generate this vehicle type prediction that may be associated with the vehicle 112. The vehicle type prediction may be generated based on the collected real-time data, the retrieved historical data, etc. The generated vehicle type prediction may also be associated with a profile of a given vehicle 112. This profile may also be used at least in part to generate a charging point location prediction. The profile may be part of the historical data utilized by the system when generating a charging location prediction. The profile for a given vehicle 112 may consider end user preferences such as preferred routing, parking, etc. In the event that a given vehicle is determined to be an electric vehicle other data such as preferences around use of cheapest charging point in an area, closest charging point to a given POI (e.g., event or stadium) or POI Type (e.g., restaurants), etc. may also be stored in the vehicle's profile.

In another embodiment, the processor 202 may be configured to generate the vehicle type prediction based on an output of the ML model 202F. As discussed above, the ML model may be a pre-trained model that may be trained on the historical training dataset to output the vehicle type prediction for a given vehicle 112. The processor may be configured to apply the ML model to the collected real-time data and the retrieved data associated to determine the vehicle type prediction. The ML model may generate the prediction by leveraging the learned patterns and knowledge from the historical training dataset(s) associated with one or more vehicles.

The vehicle type prediction generated may include, but is not limited to, information on vehicle size, weight, range, make/model, year, age, condition, and determination on if the vehicle is electric powered (e.g., EV), hybrid, plugin hybrid, traditional gasoline powered, hydrogen powered, etc. If the vehicle type is determined to utilize electric vehicle charging (e.g., full EV or plugin hybrid) other information specific to EV use may also be collected by the system 100 in addition to the vehicle type prediction. Such information may include battery information, compatible charger information, end user preferences, etc.

In yet another embodiment, the system 100 may generate a vehicle type prediction for at least one additional vehicle with a similar profile or behaviours as the first vehicle 112. For example, if one vehicle is commonly parked at known EV charging locations and driven for a certain range only to return to the EV charging location, another vehicle which is operated in a similar manner may be determined by the system 100 to be an electric vehicle of some sort. This prediction may be further refined based on available information to determine make/model, range, etc. of the additional identified EVs. This is useful for many reasons, one of which being that there is lack of compatibility between some charge points and some EVs.

At step 312, a charge point location may be predicted by the system 100. In this example, the charge point location maybe be predicted by use of the ML model, the determined/predicted vehicle type, and driving data collected for vehicle 112. The vehicle type prediction 311 may be optional in some embodiments and the vehicle type may already be known by the system 100 other embodiments. See FIG. 5 for more detail on charge point location predictions.

At step 314, an output may be generated. In an embodiment, the processor 202 and memory 204 may be configured to generate the output. The processor, memory, etc. may be configured to generate the output based on the generated vehicle type prediction and/or charger location prediction. In an embodiment, the generated output may include at least updating the vehicle profile for the given vehicle 112 and other vehicles as well as one or more location databases with EV charger location data. The charger location data may be predicted and/or confirmed via feedback from one or more vehicles.

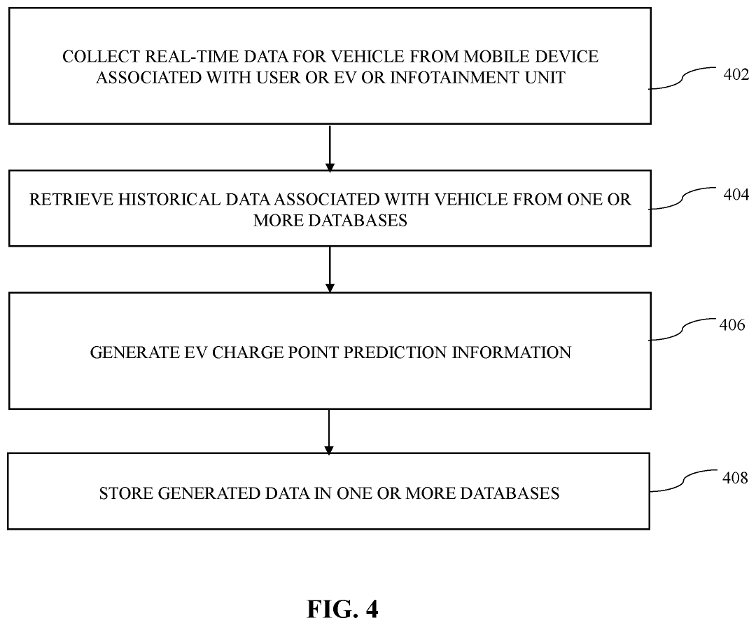

At 316, the generated output(s) may be stored. In an embodiment, the processor 202 may be configured to store the generated output in any of the following: the memory 204, the cloud 106, databases 104A, server 104B, etc. The output data may also be sent to one or more other systems, applications, etc. for use in mapping, routing, civic planning, etc. The processor 202 may be further configured to utilize the output(s) of one or more charge point locations to determine metadata about those charge points (see FIG. 4).

FIG. 4 is a flowchart that illustrates an exemplary method for charging point location prediction, in accordance with an embodiment of the disclosure. FIG. 4 is explained in conjunction with elements from FIG. 1, FIG. 2A, FIG. 2B, and FIG. 3. With reference to FIG. 4 the operations shown may be executed by any computing system, for example, by the apparatus 102 of FIG. 1 and its processor 202 of FIG. 2A.

At step 402, real-time driving data for vehicle 112 may be collected. In an embodiment, the apparatus 102 may be configured to collect the real-time driving and parking data for the vehicle 112 from the mobile device 108 associated with the user 108A (of the vehicle 112) and/or an infotainment unit 110 of the vehicle 112. The collected real-time data includes driving patterns, parking locations, etc.

At step 404, the apparatus 102 may be configured to retrieve historical charging data associated with the vehicle 112 from the one or more databases 104A.

In this embodiment, the system 100 and/or apparatus 102 may be configured to identify a location as a charging point and capture information and metadata about said point (step 406). Specifically, the apparatus 102 may be configured to identify a location, POI, etc. as a charging point based on amongst other things, an analysis of movement data of the vehicle 112. Such movement data may be obtained from the mobile device 108 associated with the user 108A of the vehicle 112. Movement data (e.g., an extended lack of movement indicates parking) of at least one additional mobile device, location data, CAN bus information, and one or more pre-stored charging locations may also be referenced to identify/predict a charging location.

For example, the apparatus 102 may be configured to identify a location as a charging point based on the correlation of the location of the vehicle 112 with the one or more pre-stored charging locations and the time spent at said location. If the vehicle 112 stops at the location for a first-time period (say 45 minutes), then it may be deemed that such stop may correspond to a charging event for the vehicle 112. The location data may be correlated with the one or more pre-stored charging locations, such as in the one or more databases 104A of the mapping platform 104, to determine whether the vehicle 112 is stopped at the charge station, near it, or just merely stopped for some other non-charging event. If the system 100 determines a charge has taken place, statistics about the length of the charging event can be captured/inferred and may be stored. The apparatus 102 may further utilize the profile of the vehicle 112 to generate the charging location prediction for the vehicle 112 as discussed above. For example, if the vehicle 112 is predicted to be an EV vehicle type and the driving behavior observed includes parking at a given location for an extended period of time, it may be predicted by the apparatus that the parking location is an EV charger.

Information regarding charge events/charge points detected by movement data of a mobile device may be confirmed from CAN bus data, data provided by charge point operators (when available), etc. This confirmation is optional depending on how system 100, apparatus 102, etc. is configured.

The disclosed system 100 may be able to recommend one or more charging points to the user 108A of the vehicle 112 using the crowd-sourced data (e.g., charge point locations and their properties) and EV-specific data (e.g., charge curve). The ability to crowd source this charging data from multiple sources (like multiple EVs) lessens the dependence on the charging point operators for such data.

At 408, the generated charge point information may be stored. In an embodiment, the apparatus 102 may be configured to store the generated information in the one or more databases 104A. In at least one embodiment, the processor 202 may be configured to store the generated charging point location prediction in the one or more databases 104A, as described, for example, in FIG. 1 and FIG. 3 (at 314 and 316).

The stored information may also be used for routing a vehicle based on the vehicle's navigation system. The vehicle navigation system may correspond to a technology that may be integrated into a vehicle that provides real-time guidance and an assistance for drivers to navigate their routes efficiently and accurately. Typically, the vehicle navigation system may include a GPS (Global Positioning System) technology and software that offers turn-by-turn directions, map displays, and often include features like traffic updates, points of interest, and voice guidance, enabling drivers to plan and follow routes, find destinations, and reach their destinations with greater convenience, safety, and precision.

The stored information may also be used for vehicle control. The vehicle control system for a vehicle may correspond to an integrated electronic and software system that may be responsible for managing and regulating various aspects of one or more operations of a vehicle. The vehicle control system may encompass functions such as power distribution to the electric motors, battery management, regenerative braking control, thermal management, traction control, and overall vehicle performance optimization. It monitors critical parameters, adjusts power delivery, and ensures the efficient and safe operation of a vehicle, contributing to its performance, range, and reliability. Such control may be asserted by the vehicle's ECU and/or autonomous vehicle control system.

The vehicle electronic control unit (ECU) for the vehicle may be a specialized computerized component responsible for managing and coordinating the various electrical and electronic systems within the vehicle. The vehicle ECU may play a pivotal role in controlling functions such as motor drive, battery management, energy regeneration, thermal management, and overall vehicle performance optimization. The ECU may continuously process data from sensors throughout the vehicle, making real-time decisions to ensure efficient and safe operation, maximize energy utilization, and deliver a smooth and responsive driving experience in the context of an electric powertrain.

The autonomous vehicle control system associated with a vehicle may be an advanced and integrated set of hardware and software technologies that enable the vehicle to operate without human intervention. The autonomous vehicle control system may include various sensors, such as cameras, lidar, radar, and ultrasonic sensors, to perceive surroundings of a vehicle and detect obstacles, pedestrians, and road conditions. The control system may further process the sensor data, making real-time decisions on vehicle speed, steering, braking, and other driving tasks to navigate safely and efficiently. Further, it may also incorporate mapping and localization algorithms to determine the vehicle's precise position on the road. The combination of autonomous capabilities and an electric powertrain contributes to the development of environmentally friendly and self-driving transportation solutions. It should be noted that the example vehicle 112 shown in FIG. 1 may be representative of any vehicle including consumer cars, trucks, motorbikes, etc. as well as commercial vehicles, industrial vehicles, etc.

Accordingly, blocks of the flowchart of FIG. 4 support combinations of means for performing the specified functions and combinations of operations for performing the specified functions. It will also be understood that one or more blocks of the flowchart, and combinations of blocks in the flowchart, can be implemented by special-purpose hardware-based computer systems which perform the specified functions, or combinations of special-purpose hardware and computer instructions.

Alternatively, the system 100, apparatus 102, etc. may comprise means for performing each of the operations described in this disclosure and the parts between which are interchangeable. In this regard, according to an example embodiment, examples of means for performing operations may comprise, for example, the processor 202 and/or a device or circuit for executing instructions or executing an algorithm for processing information as described above.

FIG. 5 is a diagram of a parking lot wherein an embodiment of the presently disclosed system 100, method, apparatus 102, etc. is utilized. As shown in FIG. 5, a parking lot 500 may feature a row of parking spots 501. These spots, spaces, etc. may be rows as shown or single parking spots, parallel street parking, etc. In parking lot 500 there is at least one EV charger 506. In this example, there are also two cars present. Car 502 is a gasoline powered car while EV 504 is an electric vehicle.

In this example, the EV charge location 506 is predicted by the apparatus based on the real-time and historic driving data for EV 504 as well as car 502. EV 504 drives from parking lot 500 each day and returns to the same area (as confirmed by GNSS data, image data, NFC data, etc.) within the parking spots 501. EV 504 drives a certain amount each day and stops at various POIs such as restaurants, stores, and office buildings but never stops at a gasoline station POI. Based on these factors, the apparatus may deduce that EV 504 runs mostly (or entirely) off electricity and that, given its routine parking location, that there is most likely an EV charging location where EV 504 parks for longer periods. This prediction may also be further strengthened by the observed driving and parking patterns of car 502. If car 502 also drives regularly from the parking lot 500 and makes stops at a gasoline station (confirmed by POI data and GNSS data) but never parks in the same area (e.g., parking spot, row, etc.) as the EV 504 parks, the system 100 may deduce that the EV charger 506 is located near where one or more EVs commonly park.

Referring back to FIG. 3, the machine learning model 202F may also be used to analyze the data captured from parking lot 500 as well as the driving patterns and parking patterns of vehicles (502 and 504) which frequent the lot. Based on this information, the machine learning model may predict both vehicle type information for various cars, trucks, motorbikes, etc. and also determine the location of one or more EV charging stations.

In some embodiments, metadata about a given EV charge location may also be determined by system 100. For example, if image data of the electric vehicle 504 is obtained by way of vehicle cameras, traffic cameras, etc. the system 100 can deduce that the charging location 506 can accommodate certain makes/models of EV. This type of determination can also be made based on known charging characteristics for different types of EV battery, etc. For example, if EV 504 routinely drives a certain range (e.g., 200 miles) before returning to the charging location 506 and the car parks for a minimum of 4 hours at a time the system 100 may deduce the EV 504 has a certain battery capacity, charge rate, etc. This information may be observed for multiple vehicles which visit a given charge point to then also deduce the EV charge point's capabilities.

Such capabilities (and other metadata about the charge point) might include but are not limited to types of compatible charge cord/ports, overall capacity, available charging cords at a given location, available parking spots and parking spot size, etc.

In some other embodiments, the predicted charge point location information may be updated in real time to account for a given charge point being blocked, disabled, etc. For example, if EV 504 no longer parks at charger 506 and instead car 502 begins parking in the area the system 100 may conclude charger 506 is out-of-order, etc. Thus, the system 100 may routinely update its one or more databases of charge point locations in real-time or near real-time based on driving and parking behavior of one or more vehicles.

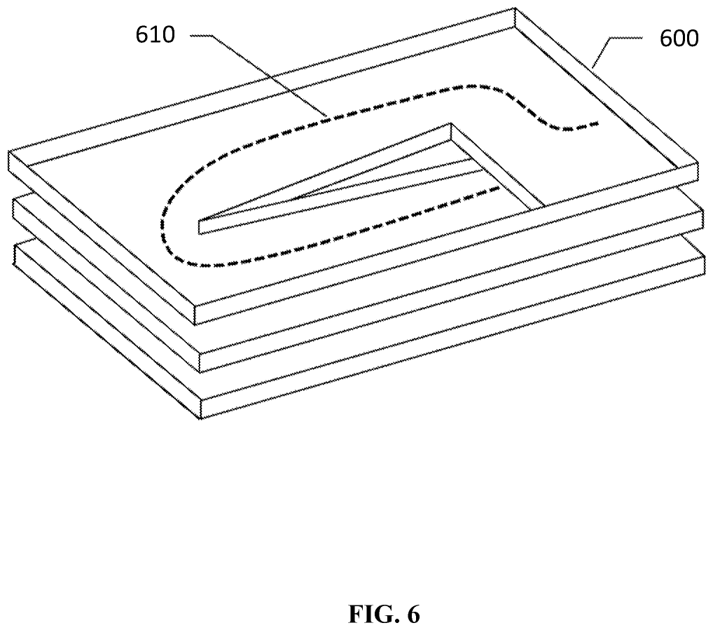

FIG. 6 illustrates a diagram of a parking garage wherein an embodiment of the presently disclosed method is utilized for routing. As shown in FIG. 6, the system 100 may generate routing information for routing one or more vehicles to an appropriate parking location. In this example, a parking garage 600 is shown wherein a route 610 is provided. This route 610 may be used to control an automated or high assisted driving vehicle to navigate to a predicted electric vehicle charging location. Such routing information could also be used to navigate gasoline powered cars, etc. to parking spots not designated as EV charging spots to keep those spots open for EVs. It should be noted that the route 610 information for EV's may also be recorded by the system 100 for use in its predictions. For example, if EVs always follow a similar route 610 in a given parking garage 600 to park in a given area of said garage, the system 100 may deduce this route 610 is an optimized route for EVs to travel to reach a charge point. An end user could, in some examples, exit their EV at the mall entrance with the system 100 automatically guiding their EV along route 610 to an EV charger while the end user shops. The routing information could also be suggested to EV users when they enter the garage 600.

The vehicles mentioned herein include parts related to mobility, such as a powertrain with an engine, a transmission, a suspension, a driveshaft, and/or wheels, etc. The vehicles may be a non-autonomous vehicle or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, a graphical user interface (GUI) may be integrated into one or more vehicles, which may include assisted driving vehicles such as autonomous vehicles, highly assisted driving (HAD), and advanced driving assistance systems (ADAS). Any of these assisted driving systems may be incorporated into the GUI. Alternatively, an assisted driving device may be included in the vehicle. The assisted driving device may include memory, a processor, and systems to communicate with the GUI. In one embodiment, the vehicle may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such a vehicle may also be driven in a manual mode in which the human operator exercises a degree of control over the movement of the vehicle. The vehicle may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. An apparatus comprising at least one processor and at least one memory including computer program code, the at least one memory and computer program code configured to, with the processor, cause the apparatus to at least:
collect real-time driving data for at least one vehicle from a mobile device associated with a user of the vehicle or a navigation unit of the vehicle, wherein the collected real-time driving data includes at least parking location information for the vehicle;
retrieve historical driving data associated with the at least one vehicle from one or more databases;
retrieve point of interest (POI) data from one or more databases;
generate a vehicle type prediction associated with the vehicle based on the collected real-time driving data, the retrieved historical driving data, and the POI data, wherein the generated vehicle type prediction is stored in the one or more databases; and
generate an electrical vehicle charge point location prediction based on at least the vehicle type prediction and parking location information for at least one vehicle.

2. The apparatus of claim 1, wherein the electrical vehicle charge point location prediction is based on the vehicle type prediction and parking location information for at least two vehicles.

3. The apparatus of claim 1, wherein the electrical vehicle charge point location prediction is based on aggregated vehicle type prediction and parking location information for vehicles in a parking lot or parking garage.

4. The apparatus of claim 1, wherein the collected parking location information includes image data of at least one parking spot.

5. The apparatus of claim 1, wherein the collected parking location information includes frequency data for parking at a predesignated electric vehicle charge spot.

6. The apparatus of claim 1, wherein the collected parking location information includes frequency data for parking at a gasoline pump.

7. The apparatus of claim 1, wherein the historical driving data includes vehicle driving range or historical parking information for the vehicle.

8. The apparatus of claim 1, wherein the electrical vehicle charge point location prediction is utilized to control at least one of: a vehicle navigation system, a vehicle control system, a vehicle electronic control unit, or an autonomous vehicle control system associated with the EV.

9. The apparatus of claim 1, wherein the electrical vehicle charge point location prediction is generated as a probability score.

10. The apparatus of claim 1, wherein the at least one processor and the at least one memory including computer program code are configured to, with the processor, cause the apparatus to also:
provide, as an input, the collected real-time driving data, the retrieved historical driving data, and parking location information to a machine learning (ML) model; and
receive, as an output from the ML model, the electrical vehicle charge point location prediction for the EV.

11. A method comprising:
collecting real-time driving data for at least one vehicle from a mobile device associated with a user of the vehicle or a navigation unit of the vehicle, wherein the collected real-time driving data includes at least parking location information for the vehicle;
retrieving, by a processor, historical driving data associated with the at least one vehicle from one or more databases;
retrieving, by a processor, point of interest (POI) data from one or more databases;
generating, by a processor, a vehicle type prediction associated with the vehicle based on the collected real-time driving data, the retrieved historical driving data, and the POI data, wherein the generated vehicle type prediction is stored in the one or more databases; and
generating, by a processor, an electrical vehicle charge point location prediction based on at least the vehicle type prediction and parking location information for at least one vehicle.

12. The method of claim 11, wherein the electrical vehicle charge point location prediction is based on the vehicle type prediction and parking location information for at least two vehicles.

13. The method of claim 11, wherein the electrical vehicle charge point location prediction is based on aggregated vehicle type prediction and parking location information for vehicles in a town, city, or neighborhood.

14. The method of claim 11, wherein the collected parking location information includes image data of at least one parking spot.

15. The method of claim 11, wherein the collected parking location information includes frequency data for parking at a predesignated electric vehicle charge spot.

16. The method of claim 11, wherein the collected parking location information includes frequency data for parking at a gasoline pump.

17. The method of claim 11, wherein the historical driving data includes vehicle driving range or historical parking trends for the vehicle.

18. The method of claim 11, wherein the electrical vehicle charge point location prediction is utilized to control at least one of: a vehicle navigation system, a vehicle control system, a vehicle electronic control unit, or an autonomous vehicle control system associated with the EV.

19. The method of claim 11, wherein the electrical vehicle charge point location prediction is used to cede control of an autonomous vehicle control system.
